(19) United States
(12) Patent Application Publication
(10) Pub. No.: US 2024/0306830 A1
(43) Pub. Date: Sep. 19, 2024

(54) Pre-salted beverage straw

(71) Applicant: Jill Cynthia Cash, Thompsons Station, TN (US)

(72) Inventor: Jill Cynthia Cash, Thompsons Station, TN (US)

(21) Appl. No.: 18/120,546

(22) Filed: Mar. 13, 2023

(51) Int. Cl. A47G 21/18; A23L 2/56; A23L 29/238; A23L 29/256; A23L 29/269; A23L 29/281; A23L 29/30; B31D 5/00; C09J 5/00; C09J 105/12; C09J 189/04; C12G 3/06

(52) U.S. Cl. CPC A47G 21/183; A23L 2/56; A23L 29/238; A23L 29/256; A23L 29/27; A23L 29/284; A23L 29/30; B31D 5/0095; C09J 5/00; C09J 105/12; C09J 189/04; C12G 3/06; C09J 2405/00; C09J 2489/00

(57) ABSTRACT

A beverage drinking straw having a pre-salted tip/end for use with alcoholic and non-alcoholic beverages provides a plastic beverage drinking straw having a tip/end and a solid substance attached to the tip/end by a food grade adhesive. A method for producing the beverage straw with precoated tip/end is also provided.

### BACKGROUND OF INVENTION

### 1. Field of the Invention

This invention relates to a beverage straw with one pre-salted tip/end for alcoholic and non-alcoholic beverages. More particularly, but not by way of limitation, the invention provides a beverage straw having margarita salt attached to the tip/end by a food-grade adhesive.

### 2. Discussion

A margarita is an alcoholic drink made, most commonly, from a lime-juice mix combined with measured quantities of tequila and triple sec. Over the last several years, margaritas have gained increased popularity in restaurants, drinking establishments, and homes. Margaritas are served either over ice or frozen. Most restaurants and bars utilize a machine which freezes and stores a quantity of frozen margarita for easy dispensing into beverage containers. The margarita machine also reduces the time and labor required for a bartender to prepare a margarita.

Margaritas are commonly served in a beverage container whose rim has been coated with margarita salt, a coarse salt readily available at grocery stores, supermarkets, and food service companies. The bartender prepares the beverage container by slicing a lime, cutting a wedge from the sliced lime, rubbing the lime wedge around the rim of the beverage container to create a film of lime juice on the rim, and then dredging the juiced rim in a container of margarita salt.

Whereas the margarita machine reduces the labor to mix the drink, much labor is required to prepare the beverage container. A sharp knife is required to slice the lime, thereby creating an opportunity for an accidental cut. The margarita salt may become contaminated by other substances used behind the bar.

Margaritas are not the only alcoholic drinks commonly served in a beverage container having a salted rim. A salty dog (grapefruit juice and vodka or other liquor) is commonly served in a beverage container whose rim is salted and some patrons prefer beer served in a similar container.

The present invention provides a beverage straw having a coating of margarita salt attached securely to the tip/end by a food-grade adhesive. The pre-salted straw saves time for the bartender, ensures consistency and quality control, and eliminates the potential for contamination of the margarita salt.

### SUMMARY OF THE INVENTION

An object of the present invention is to provide a beverage straw with a pre-salted tip/end for use in conjunction with margaritas.

Yet another object of the present invention is to provide a beverage straw with a pre-salted tip/end to reduce the labor required by a bartender to prepare the beverage container.

Another object of the present invention is to provide a method of production for preparing a beverage straw with a pre-salted tip/end.

Other objects, features, and advantages of the present invention will become clear from the following description of the preferred embodiment when read in conjunction with the accompanying drawings and appended claims.

### BRIEF DESCRIPTION OF THE DRAWINGS

FIG. 1 is a view of applicant's beverage straw invention showing margarita salt attached to the tip/end of the beverage.

FIG. 2 illustrates a step in applicant's method of attaching the margarita salt to the tip/end of the beverage straw.

FIG. 3 illustrates another step in applicant's method of attaching the margarita salt to the tip/end of the beverage straw.

FIG. 4 illustrates another step in applicant's method of attaching the margarita salt to the tip/end of the beverage straw.

FIG. 5 illustrates another step in applicants method of attaching the margarita salt of the end of the beverage straw.

FIG. 6 illustrates another step in applicants method of attaching the margarita salt of the end of the beverage straw.

FIG. 7 illustrates another step in applicants method of attaching the margarita salt of the end of the beverage straw.

FIG. 8 illustrates another step in applicants method of attaching the margarita salt of the end of the beverage straw.

### DETAILED DESCRIPTION OF THE INVENTION

In the following description of the invention, like numerals and characters designate like elements throughout the figures of the drawings.

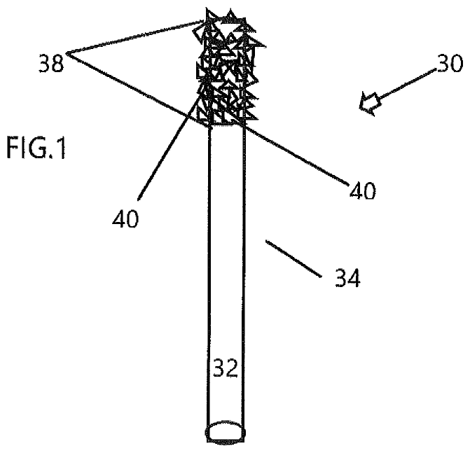

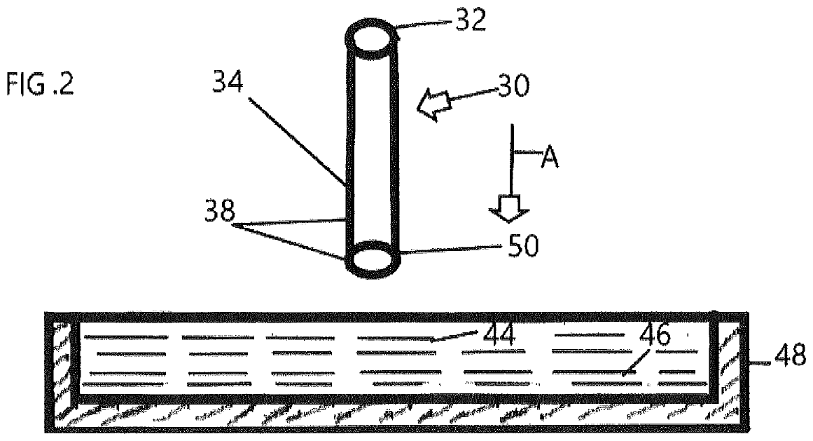

Referring generally to the drawings and more particularly to FIGS. 1 and 2, a beverage straw 30 has an end 32 and another end 34. The upstanding wall 34-1 terminates in a tip/end of beverage straw 38. Margarita salt particles 40 are retained on the tip/end of beverage straw 38 by a coating of food-grade adhesive 42.

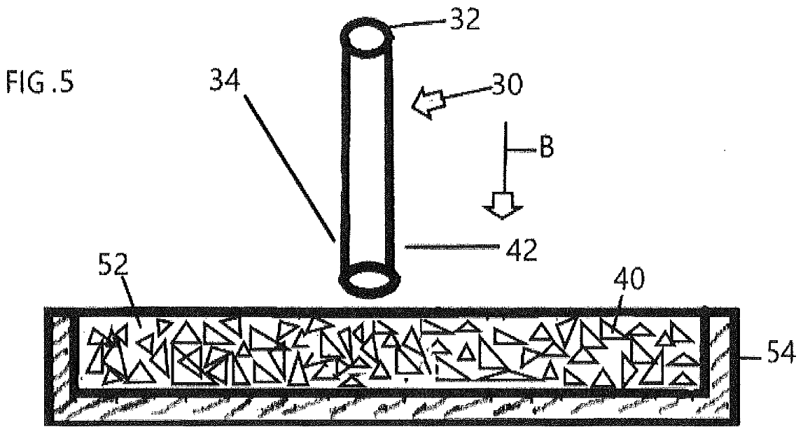

Referring now to FIGS. 2-8, the process of producing the beverage straw with pre-salted tip/end is shown in detail. FIGS. 2-4. Illustrate the application of the coating of food-grade adhesive 42 to the tip/end of beverage straw 38 of the beverage straw 30, and FIGS. 5-8 illustrate the application of the margarita salt particles 40 to the food-grade adhesive coating 42 on the tip/end beverage straw 38.

Still referring to FIGS. 2-8 and to FIG. 2 in particular, the inverted beverage straw 30 is moved downwardly along A, thereby causing the tip/end of beverage straw approach the surface 44 of a food-grade adhesive coating solution 46 contained in a reservoir 48.

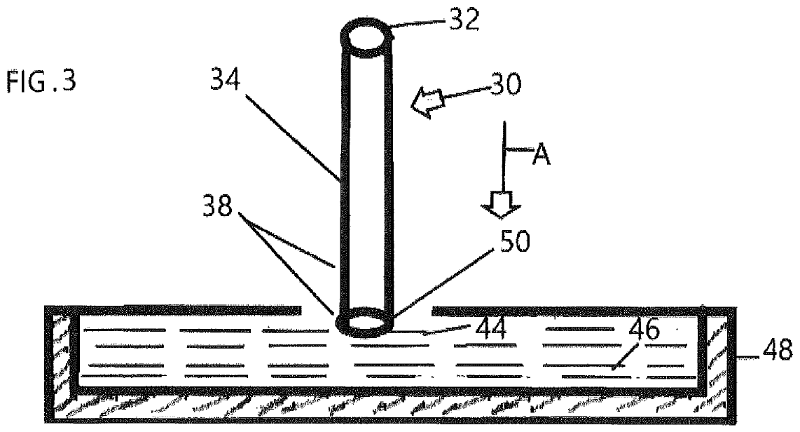

Referring now to FIG. 3, the inverted beverage straw 30 is directed along A until the tip/end of beverage straw 38 is uniformly in contact with the surface 44 of the food-grade adhesive coating solution 46. As a result of the contact between the tip/end of beverage straw 38 and the food-grade adhesive coating solution 46, a layer of food-grade adhesive coating 42 is applied to the tip/end of beverage straw 38.

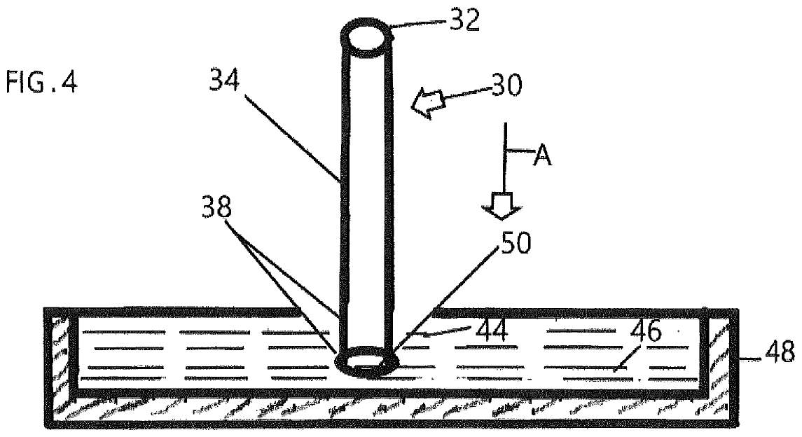

Referring now to FIG. 4, the inverted beverage straw 30 is further directed along A until the beverage straw 38 is immersed slightly below the surface 44 of the food-grade adhesive coating solution 46. The immersion of the tip/end of beverage straw 38 in the food-grade adhesive coating solution 46 results in application of a coating of the food-grade adhesive solution 46 to the tip/end of beverage straw 38 of the beverage straw 30. Due to the immersion of the tip/end of the beverage straw 38, the coating of food-grade adhesive 42 is also applied to the inside side 50 of the beverage straw 38.

Although the food-grade adhesive coating 46 is referred to for convenience as a solution, it will be understood by one skilled in the art that the food-grade adhesive coating 46 solution may also take the form of a colloidal suspension or a gel.

Referring now to FIGS. 5-8 and to FIG. 5 in particular, the inverted beverage straw 30, with a still wet coating 42 of the food-grade adhesive coating solution 46 on the tip/end of beverage straw 38, is moved downwardly along B, thereby causing the coated beverage straw to approach the surface 52 of the margarita salt particles 40 contained in a reservoir 54.

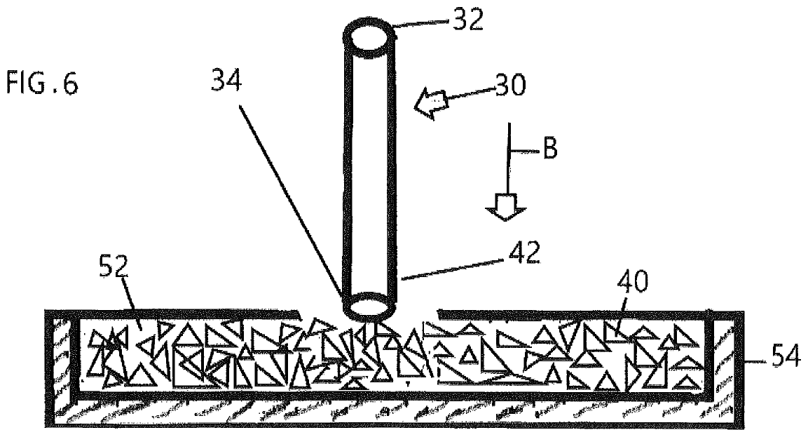

Referring now to FIG. 6, the inverted beverage straw 30, with a still-wet coating 42 of the food-grade adhesive coating solution 46 on the beverage straw 38 is directed along B until the coated beverage straw is uniformly in contact with the margarita salt particles 40 contained in the reservoir 54. As a result of the contact between the still-wet coated beverage straw 38 and the margarita salt particles 40, a layer of margarita salt 40 is applied to the still-wet coating 42 of food-grade adhesive coating solution 46.

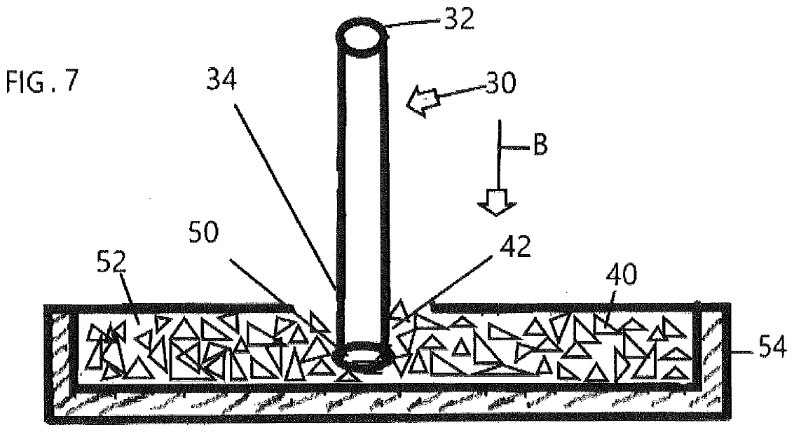

Referring now to FIG. 7, the inverted beverage straw 30 is further directed along B until the coated tip/end of the beverage straw is immersed slightly below the surface 52 of the margarita salt particles 40. Contact of the coated tip/end of beverage straw with the margarita salt particles 40 results in application of a layer of margarita salt 40 to the coated tip/end of the beverage straw 30. Due to the immersion of the coated straw below the surface of 52 of the margarita salt particles 40 margarita salt particles 40 area also applied to the inside 50 of the coated straw.

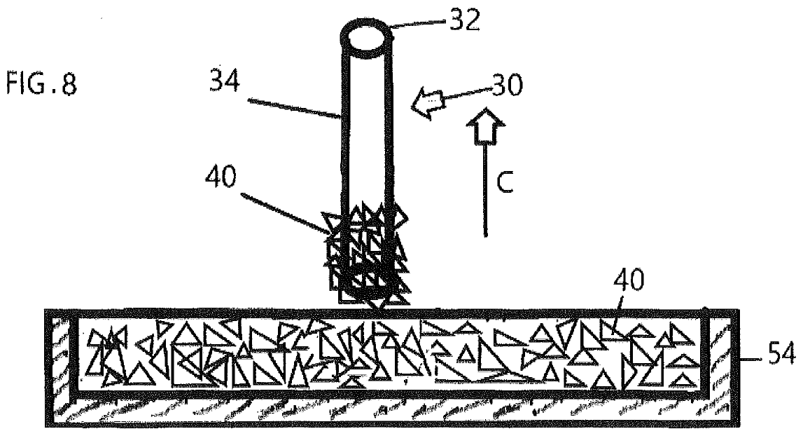

Referring now to FIG. 8, the beverage straw 30, with a layer of margarita salt 40 attached to the still-wet coating 42 of the food-grade adhesive coating solution 46 on the beverage straw 38, is removed from the margarita salt container 54 as indicated by arrow C and set aside. Within a few minutes, the coating 42 of the food-grade adhesive dries, thereby securing the margarita salt particles 40 to the tip/end of beverage straw 38 of the beverage straw 30.

Food-grade substances which can be used to create the food-grade adhesive solution includes guar gum, agar, xanthan gum and gelatin. Guar gum, which is well known in the food industry, is sold as a white to yellowish odorless white powder. Guar gum is available in different viscosities and different granulometries depending on the desired viscosity. Guar's viscosity is a function of temperature, time, and concentration. One advantageous property of guar gum is that it thickens without the application of heat.

Xanthan gum is mainly considered to be non-gelling and used for the control of viscosity. It hydrates rapidly in cold water without lumping to give a reliable viscosity. Xanthan's most important property is its very high low-shear viscosity coupled with its strongly shear-thinning character. The relatively low viscosity of high shear means it is easy to mix, pour, and swallow but its high viscosity at low shear give good suspension and coating properties.

Like xanthan gum, agar is a hydrocolloid gum.

Xanthan gum is mainly considered to be non-gelling and used for the control of viscosity. It hydrates rapidly in cold water without lumping to give a reliable viscosity. Xanthan's most important property is its very high low-shear viscosity coupled with its strongly shear-thinning character. The relatively low viscosity at high shear means it is easy to mix, pour, and swallow but its high viscosity at low shear give good suspension and coating properties.

Like xanthan gum, agar is a hydrocolloid gum commonly used in food and beverage formulations. Agar (also referred to as agar-agar) produces a firm and brittle gel

Gelatin has been used in food products for many years. Unlike guar gum and xanthan gum, gelatin normally requires low heat (less than about 140 degrees Fahrenheit) to dissolve (i.e., for hydration and thickening). Commercially available flavored gelatin products found in supermarkets and grocery stores include a preservative such as butylated hydroxytoluene (BHT), an antioxidant which preserves color and taste. If not already available in the gelatin, a preservative should be added to the food-grade adhesive coating solution according to applicant's invention. Likewise, a preservative should be added if the food-grade adhesive coating solution utilizes guar, xanthan, or agar.

Some people object to the use of gelatin obtained from animals. A soy-based gelatin-like material has been created from water, fructose, high-gelling soy protein and a carrageenan (a sea word). Called NuSoy Gel, the vegetable-based gelatin substitute can also be used to secure the margarita salt to the tip/end of the beverage straw.

Traditional hard candies can also be used for the food-grade adhesive coating, although the high temperatures required to maintain a liquid form prevent the use of hard candy solutions with typical plastic beverage straws.

The beverage straw 30 illustrated herein can be plastic, paper, expanded foam, or ceramic. For backyard pool use, plastic, paper, or expanded foam will be preferred due to safety considerations. On the more formal occasions, a metal or ceramic beverage straw can be used to prepare the beverage straw with pre-salted tip/end.

The present invention has been described in the context of a beverage straw with a pre-salted tip/end as might be used for margaritas and salty dogs. The present invention also includes beverage straw with other components in the place of margarita salt. Other materials which could be attached to the beverage straw by a food-grade adhesive coating include, by way of illustration and not by way of limitation, sugar sprinkles.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be determined by the claims appended hereto and their equivalents.

What is claimed is:

1. A method of producing a beverage straw having a tip/end pre-coated with salt, the method comprising the steps of: providing a food-grade adhesive solution in a first reservoir, wherein the food-grade adhesive solution is characterized as having a surface providing a supply of margarita salt in a second reservoir; inverting the beverage straw so that the tip/end of the beverage straw is oriented downwardly just above the surface of the food-grade adhesive solution in the first reservoir; moving the beverage straw downwardly until the tip/end of the beverage straw makes uniform contact below the surface of the food-grade adhesive solution and the tip/end of the beverage straw becomes coated with the food-grade adhesive solution, moving the beverage straw upwardly away from the surface of the food-grade adhesive solution while maintaining the beverage straw in the inverted position; moving the beverage straw downwardly until the coated tip/end of the beverage straw makes uniform contact below the margarita salt and the margarita salt adheres to the coated tip/end of the beverage straw; moving the beverage straw upwardly away from the margarita salt; and restoring the beverage straw to a normal upright.

2. The method of claim 1 where in the food-grade adhesive solution consists of gelatin dissolved in water.

3. The method of claim 1 where in the food-grade adhesive solution consists of xanthan gum dissolved in water.

4. The method of claim 1 where in the food-grade adhesive solution consists of agar dissolved in water.

5. The method of claim 1 where in the food-grade adhesive solution consists of guar gum dissolved in water.

6. The method of claim 2 wherein the gelatin is kosher gelatin.

7. The method of claim 1 wherein the food-grade adhesive solution consists of a mixture of water, fructose, high-gelling soy protein, and carrageenan.

8. A method of producing a beverage straw having a tip/end pre-coated with a flavored solid substance, the method of comprising the steps of: providing a food-grade adhesive solution in a first reservoir, wherein the food-grade adhesive solution is characterized as having a surface: providing a supply of the solid substance in a second reservoir, inverting the beverage straw so that the tip/end of the beverage straw is oriented downwardly just below the surface of the food-grade adhesive solution in the first reservoir, moving the beverage straw downwardly until the tip/end of the beverage straw makes uniform contact below the surface of the food-grade adhesive solution and the tip/end of the beverage straw becomes coated with the food-grade adhesive solution, moving the beverage straw upwardly away from the surface of the food-grade adhesive solution while maintaining the beverage straw in the inverted position; moving the beverage straw downwardly until the coated end/tip of the beverage straw makes uniform contact with the solid substance and the solid substance adheres to the coated tip/end of the beverage straw, moving the beverage straw upwardly away from the solid substance; and moving the beverage straw upwardly away from the solid substance; and restoring the beverage straw to a normal upright position at rooms temperature until the food-grade adhesive dries.

9. The method of claim 8 wherein the food-grade adhesive solution consists of gelatin dissolved in water.

10. The method of claim 8 wherein the food-grade adhesive solution consists of xanthan gum dissolved in water.

11. The method of claim 8 wherein the food-grade adhesive solution consists of agar dissolved in water.

12. The method of claim 8 wherein the food-grade adhesive solution consists of guar gum dissolved in water.

13. The method of claim 9 wherein the gelatin is kosher gelatin.

14. The method of claim 8 wherein the food-grade adhesive solution consists of a mixture of water, fructose, high-gelling soy protein, and carrageenan.

15. The method of claim 8 wherein the solid substance further comprises sugar sprinkles.

16. The method of claim 8 wherein the solid substance further comprises a mixture of sugar and cocoa.

17. The method of claim 8 where the solid substance further comprises chopped nuts.

18. The device of claim 8 wherein the beverage straw is made of paper.

19. The device of claim 8 wherein the beverage straw is made of metal.

20. The device of claim 8 wherein the beverage straw is made of plastic.

21. The device of claim 8 wherein the beverage straw is made of bamboo.

22. The device of claim 8 wherein the beverage straw is made of agave.

23. The device of claim 8 wherein the beverage straw is made of PHA.

24. A beverage straw having a pre-coated tip/rim for use with alcoholic and non-alcoholic beverages, the beverage straw comprising: a plastic beverage straw having a tip/end; a solid substance; and means for attaching the solid substance to the tip/end of the plastic beverage straw.

25. A ready-to-use beverage straw comprising coarse salt; means for attaching the coarse salt to the tip/end of the plastic beverage straw so the coarse salt extends around the tip/end.
